(19) United States
(12) Patent Application Publication
(10) Pub. No.: US 2014/0304014 A1
(43) Pub. Date: Oct. 9, 2014

(54) SYSTEMS AND METHODS ASSOCIATED WITH TRAVEL PLANNING

(71) Applicants: Myunghoon Lee, Seoul (KR); Dongyun Youm, Seoul (KR)

(72) Inventors: Myunghoon Lee, Seoul (KR); Dongyun Youm, Seoul (KR)

(73) Assignee: STACCATOTRIP, San Francisco, CA (US)

(21) Appl. No.: 14/246,082

(22) Filed: Apr. 5, 2014

Related U.S. Application Data
(60) Provisional application No. 61/809,882, filed on Apr. 9, 2013.

(51) Int. Cl. G06Q 10/02; G06Q 30/02; G06Q 50/14; G01C 21/00

(52) U.S. Cl. CPC G06Q 10/02; G01C 21/00; G06Q 30/0273; G06Q 50/14
USPC 705/5; 701/400; 701/537

(57) ABSTRACT

Embodiments described herein are directed towards methods and systems that allow a content providing user to publish journals, blogs, reviews, notes, etc. associated with their travels. Using the content generated by the user, other users may be able to gain from the users traveling experiences.

### CROSS-REFERENCE TO RELATED APPLICATIONS

This application claims a benefit of priority under 35 U.S.C. §119 to Provisional Application No. 61/809,882 filed Apr. 9, 2013, which is fully incorporated herein by reference in its entirety.

### BACKGROUND INFORMATION

1. Field of the Disclosure

Examples of the present disclosure are related to systems and methods for creating travel log and assisting travel-planning. Specifically, embodiments are related to generating an itinerary for a group of users or single user traveling to a destination based on the interactions with content associated with the destination by the users within the group or the single user.

2. Background

The internet has made travel planning easier and more efficient. For example, when users are planning a vacation, the users may book flights, hotels, meals, activities, etc. via the internet.

The internet has enabled users to publish information associated with their travels in the form of blogs, reviews, etc. Websites that publish the users' travel information require others to sort through the information to find relevant information. For example, while finding out information about a certain destination, a user may be required to perform a keyword search on “best restaurants,” “best family activities,” etc. Based on the search results, the user is then required to determine what activities to participate in while at the destination. However, it may be time consuming for a user to plan a trip to a destination that the user knows nothing or relatively little about.

Furthermore, travel websites receive advertisement revenue from third parties when displaying information generated by users based on their travels. The third party advertisements may direct viewers of the content to attractions, restaurants, and/or destinations. However, conventional websites do not let the content generators determine which advertisements should be displayed with the user's content or the layout of the content and advertisements.

Accordingly, needs exist for easy and effective methods and systems that allow a travel group to generate an itinerary for a trip, and allow content generators to select the layout and advertisements presented on a website.

### BRIEF DESCRIPTION OF THE DRAWINGS

Non-limiting and non-exhaustive embodiments of the present invention are described with reference to the following figures, wherein like reference numerals refer to like parts.

FIG. 1 depicts one topology for assisting groups of users make travel plans.

FIG. 2 depicts one embodiment of a client computing device.

FIG. 3 depicts one embodiment of a travel server.

FIG. 4 depicts one embodiment of a travel server.

FIG. 5 illustrates a method for determining a travel itinerary for a group of travelers.

FIG. 6 depicts one embodiment of a graphical user interface presenting content on a client computing device.

FIG. 7 depicts one embodiment of a graphical user interface presenting content on a client computing device.

FIG. 8 depicts one embodiment of a graphical user interface presenting content on a client computing device.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent to one having ordinary skill in the art, that the specific detail need not be employed to practice the present embodiments. In other instances, well-known materials or methods have not been described in detail in order to avoid obscuring the present embodiments.

Embodiments described herein are directed towards methods and systems that allow a content providing user to publish journals, blogs, reviews, notes, etc. associated with their travels. Using the content generated by the user, other users may be able to gain from the users traveling experiences.

Embodiments may also be configured to provide support to non-profit organizations that are associated with tourism and/or the user generated content via advertisement revenue received from third parties. For example, non-profits may be charities associated with travel, such as a local tourism division, World Tourism Organization (UNWTO), and/or International Social Tourism Organization (ISTO). In embodiments, the advertisements from third parties and the supported non-profit organizations may be selected by the user generating the content, wherein the selected advertisements and/or the supported non-profit organization may be associated with the user generated content.

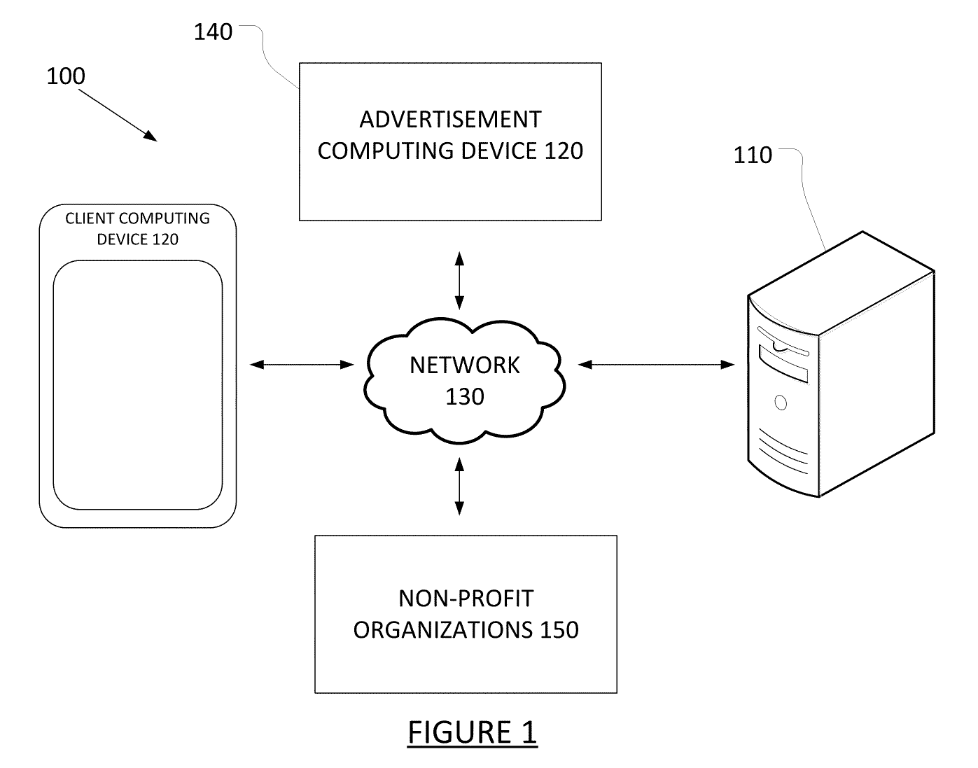

Turning now to FIG. 1, FIG. 1 depicts one topology 100 for assisting groups of users in making travel plans. Topology 100 may include a travel server 110, client computing device 120, an advertisement computing device 140, and at least one non-profit organization 150. The elements depicted in topology 100 may be communicatively coupled to each other over network 130.

Network 130 may be a wired or wireless network such as the Internet, an intranet, a LAN, a WAN, a NFC network, Bluetooth, infrared, radio frequency, a cellular network or another type of network. It will be understood that network 130 may be a combination of multiple different kinds of wired or wireless networks.

Travel server 110 may be a computing device, such as a general hardware platform server configured to support mobile applications, software, and the like executed on client computing device 120 and/or advertisement computing device 140. Travel server 110 may include physical computing devices residing at a particular location or may be deployed in a cloud computing network environment. In this description, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Travel server 110 may include any combination of one or more computer-usable or computer-readable media. For example, travel server 110 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

Travel server 110 may be configured to receive content from client computing device 120, receive travel plans from client computing devices 120, receive advertisements from advertisement computing devices 140, determine itineraries for groups of users via client computing devices 120, and transmit revenue associated with the advertisements to client computing devices 120 and non-profit organizations 150.

Client computing device 120 may be a smart phone, tablet computer, laptop computer, personal data assistant, or any other type of device with a hardware processor that is configured to process instructions and connect to one or more portions of network 130. Client computing device 120 may be configured to receive content generated by a user of client computing device 120, and to transmit the generated content to travel server 110. Client computing device 120 may also be configured to allow a user to select advertisements configured to be displayed along with the user generated content and the layout of the content and advertisements. Client computing device 120 may also be configured to allow the user to select non-profit organizations that may receive revenue from the advertisements, wherein the user may select a non-profit organization 150 based on the subject and location associated with the user generated content. In embodiments, the user may select a non-profit organization 150 to receive revenue from advertisements displayed with the user generated content if the non-profit organization 150 is associated with the subject of content and/or the advertisement. For example, a non-profit organization 150 associated with youth sports may receive revenue from an advertisement associated with family sporting events and user generated content associated with sports. Furthermore, client computing device 120 may be configured to receive travel plans from the user of client computing device 120, and to generate an itinerary, travel log, etc. for the travel plans based on content associated with a location and ratings of the content, wherein the ratings of the content may be made by other users or a group of users traveling together. In a further example, a non-profit organization 150 associated with local area tourism development may receive revenue from an advertisement associated with local wine tasting events and user generated content associated with wine tasting.

Advertisement computing device 140 may be a hardware computing device that is associated with an advertiser. In embodiments, an advertiser may be a company, restaurant, point of interest, website, etc. In embodiments, the advertiser may transmit advertisements configured to be presented along with the user generated content, wherein the advertisements may be banner ads, pop-up ads, audio ads, visual ads, or any other form of advertisement. Responsive to the advertisements being presented along with the user generated content, advertisement computing device 140 may transmit revenue to travel server 110. One skilled in the art will appreciate that other advertisement schemes may be performed between advertisement computing device 140 and travel server 110.

Non-profit organizations 150 may be charities associated with travel, such as a local tourism division, World Tourism Organization (UNWTO), and International Social Tourism Organization (ISTO). Non-profit organizations 150 may be categorized based on their location, supporting organization, etc. Non-profit organizations 150 may receive revenue from an advertisement supplied advertisement computing device 140 being presented with user generated content from client computing device 120, wherein the received revenue may be in the form of a donation. In embodiments, a specific non-profit organization 150 may receive revenue responsive to the non-profit organization 150 being associated with the advertisement and/or the user-generated content. For example, a non-profit organization associated with food banks in a city may be configured to receive revenue from an advertisement if the user generated content is associated with a restaurant within the city and the advertisement is also associated with restaurants.

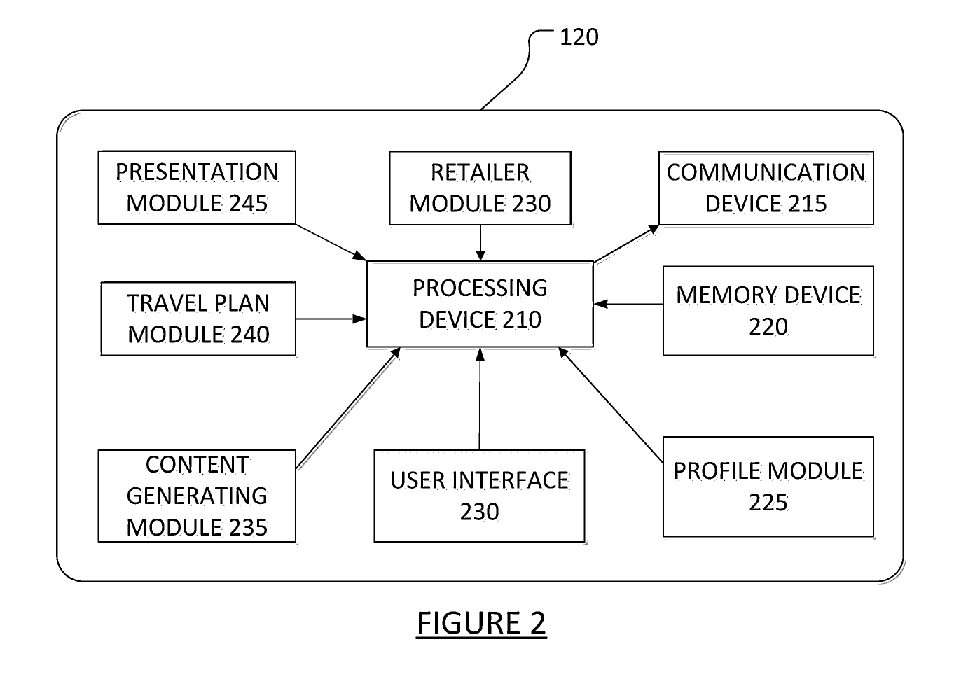

FIG. 2 depicts one embodiment of client computing device 120. Client computing device 120 may be a smart phone, tablet computer, laptop computer, a personal data assistant, or any other type of device with a hardware processor that is configured to process instructions and connect to one or more portions of network 130. Client computing device 120 may include processing device 210, communication device 215, a memory device 220, a profile module 225, a user interface 230, a content generating module 235, travel plan module 240, and a presentation module 245.

Processing device 210 may include memory, e.g., read only memory (ROM) and random access memory (RAM), storing processor-executable instructions and one or more processors that execute the processor-executable instructions. In embodiments where processing device 210 includes two or more processors, the processors may operate in a parallel or a distributed manner. Processing device 210 may execute an operating system of client computing device 120 or software associated with other elements of client computing device 120.

Communication device 215 may be a device that allows client computing device 120 to communicate with another device, e.g., a travel server or an advertisement computing device over a network. Communication device 215 may include one or more wireless transceivers for performing wireless communication and/or one or more communication ports for performing wired communication.

Memory device 220 may be a device configured to store data generated or received by client computing device 120. Memory device 220 may include, but is not limited to a hard disc drive, an optical disc drive, and/or a flash memory drive. Memory device 220 may be configured to store data associated with a user's profile, content generated by the user, advertisements selected to be presented along with the user generated content, a layout of the content and advertisements to be published in a physical media format or digital format, topics associated with the user generated content, non-profit organizations associated with different topics and/or advertisements.

Profile module 225 may be a hardware processing device configured to allow the user of a client computing device server 120 to generate and create a user profile. The user profiles may include information stored in memory device 220 and/or other storage locations. The user profile may include user information, content information, and travel information. The user information may include information identifying the user (e.g., a username or handle, number, identifier, and/or other identifying information), security login information (e.g., a login code or password), demographic information associated with users, or any other information associated with the user. The content information may include information associated with the user generated content including a location associated with the content, a place (e.g. a restaurant, theme park, point of interest, etc.) associated with the content, a time period (e.g. a day of the year, month, season, etc.) associated with the content, a time of day (e.g. morning, mid-day, night, breakfast, lunch, dinner, etc.) associated with the content, text associated with the content, media associated with the content, or any other information associated with content generated by the user. The travel information may include information associated with the user's past travels or desired travel information for the future. For example, the travel information may include information indicating that the user desires to plan a vacation for a long weekend at a certain destination at a certain period of time, and while on the vacation the user desires to visit a first number of restaurants for breakfast, visit a second number of restaurants for dinner, visit a third number of points of interest mid-day, visit a fourth number of points of interest during the evening, etc.

User interface 230 may be a device that allows a user to interact with client computing device 120, travel server 110, or advertisement computing device 140 over network 130. While one user interface is shown, the term “user interface” may include, but is not limited to being, a touch screen, physical keyboard, mouse, camera, video camera, microphone, and/or speaker. Utilizing user interface 230, a user may perform actions to enter user profile information, generate content, view content, select advertisements to be presented along with the user generated content, assign metadata to the user generated content, select a layout of the user generated content and advertisements, select a non-profit organization to receive revenue associated with the user generated content and advertisements, enter desired travel plans, select itinerary criteria for the travel plans, etc.

Content generating module 235 may be a hardware processor configured to allow a user to generate content (e.g. journals, blogs, audio content, visual content, reviews, etc.) associated with the user's travels. The content may be based on the user's feelings, experiences, etc. For example, a user's content may be reviews of restaurants, events, or entertainment, or personal notes on the user's collected information at a destination. Furthermore, the user generated content may be categorized based on a plurality of factors including location, date (e.g. day of the year, season, etc.), subject of the content (e.g. food, activity, family event, etc.), cost, etc.

Travel plan module 240 may be a hardware processor configured to allow a user to create a blank itinerary for a trip, wherein the blank itinerary may be a travel log, set of notes, schedule, etc. The blank itinerary may include a destination location (e.g. a country, city, theme park, tourist attraction, etc.), a time period (e.g. from a first date to a second date, start date to end date), length of time (e.g. one hour, two hours, etc.), cost desired to spend on the trip, number of people in the user's group, etc. The itinerary for the trip may be further broken down into a number of sub-activities that the user may desire to attend during the trip, wherein the sub-activities may include a number of breakfast restaurants, a number of lunch restaurants, a number of dinner restaurants, a number of evening points of interest to visit, a number of daytime points of interest to visit, etc. In embodiments, the user may set dates and/or times that the user desires to visit a specific location at a specific date on the blank itinerary. For example, the user may set that on the first date of the trip the user desires to visit a first restaurant for lunch and a first point of interest for an evening activity. In response to a user generated a blank itinerary, the blank itinerary may be filled with recommendations based on other users' content, such as restaurants to eat at, points of interest to visit during the day, points of interest to visit during the night, etc. The blank itinerary may be filled with activities associated with other users' generated content based on a plurality of factors, such as ratings, cost, location, time period, interactions on a social network, a travel group including the user, etc. Therefore, travel plan module 240 may be configured to dynamically generate an itinerary for the user based on the user's blank itinerary, profile, travel group, other users' generated content, and/or the ratings of the other users' generated content. The dynamically generated itinerary may be made with little or no input from the user pertaining to what activities to do while on the trip.

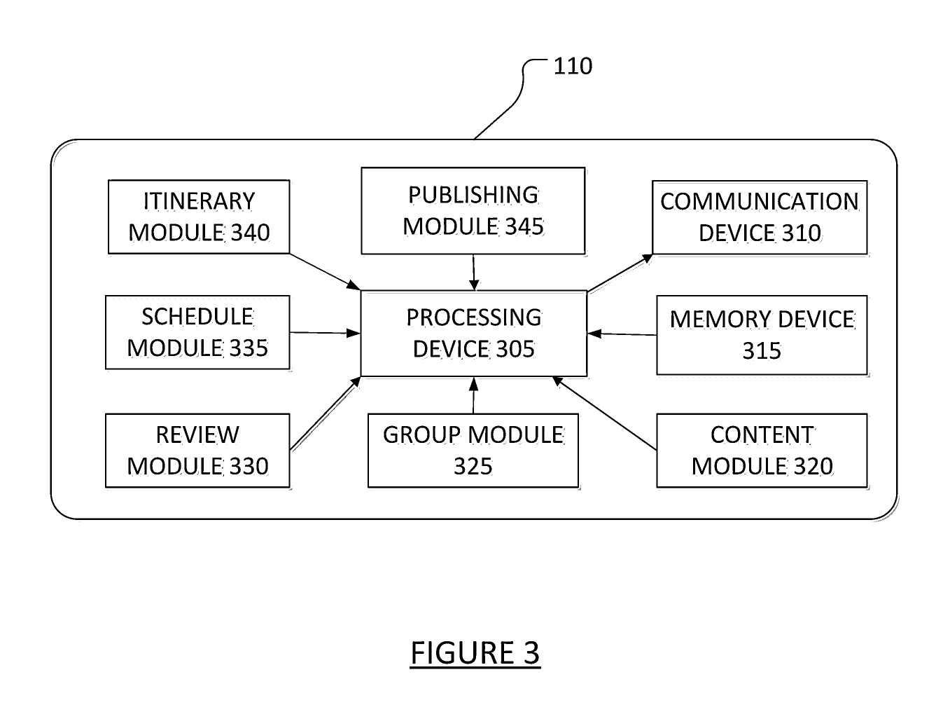

FIG. 3 depicts one embodiment of travel server 110. Travel server 110 may include a processing device 305, a communication device 310, a memory device 315, a content module 320, a group module 325, a review module 330, a schedule module 335, an itinerary module 340, and a publishing module 345.

Processing device 305 may include memory, e.g., read only memory (ROM) and random access memory (RAM), storing processor-executable instructions and one or more processors that execute the processor-executable instructions. In embodiments where processing device 305 includes two or more processors, the processors may operate in a parallel or distributed manner. Processing device 305 may execute an operating system of travel server 110 or software associated with other elements of travel server 110.

Communication device 310 may be a device that allows travel server 110 to communicate with another device over a wireless or wired network, such as network 130. For example, communication device 310 may allow travel server 110 to communicate with a client computing device 120 or an advertisement computing device 140 over a network 130. Communication device 310 may include one or more wireless transceivers for performing wireless communication and/or one or more communication ports for performing wired communication. Communication device 310 may be configured to communicate data over a plurality of different standard and/or protocols.

Memory device 315 may be a device that stores data generated or received by travel server 110. Memory device 315 may include, but is not limited to a hard disc drive, an optical disc drive, and/or a flash memory drive. In embodiments, memory device 315 may be configured to store information received from a client computing device and/or a advertisement computing device. The information stored within memory device 315 may be accessed by processing device 305, communication device 310, and/or modules 320, 325, 330, 335, 340, and 345.

Content module 320 may be a hardware processor configured to receive content generated by a user. The user generated content may be content such as journals, blogs, audio content, visual content, reviews, etc., wherein the content may be associated with the users travels. The content may be associated with the user's feelings, experiences, etc. while traveling. For example, user generated content may be reviews of restaurants, events or entertainment, sightseeing, accommodations, or personal notes on the user's collected information. The user generated content may include metadata associated with the user's travels that may be categorized, wherein the metadata may include location, date (e.g. day of the year, season, etc.), subject of the content (e.g. food, activity, family event, accommodations, sightseeing, etc.), cost, etc. Content module 320 may also be configured to receive other user's content for planning a trip. The received content may be utilized by the user to form a wish list of desired trips to take, places to visit while on a trip, etc.

Group module 325 may be a hardware processor configured to establish a travel group, wherein the travel group may include a single user or a plurality of users. Group module 325 may establish the travel group based on relationships between users within an online community, wherein the online community may be associated with a group of users that desire to organize a trip together. Therefore, the travel group may be a subgrouping of the user's social network. Such travel groups may include one or more of friendships, connections, followers, and/or other relationships between users of an online community. Group module 325 may establish relationships based on requests and acceptances received from users to establish a travel group. Establishment of a travel group may be initiated by a single communication (e.g., a request) initiated by a first user (e.g. a trip planner) requesting a travel group be formed between the first user and one or more other users. Subsequently other users may be added to the travel group via requests from the users and/or the trip planner. In embodiments, the trip planner may transmit requests other users, such as friends on a social network, and to let the other users join the travel group. Responsive to the other users joining the travel group, the other users may collaborate to plan the trip, such as setting a blank itinerary, planning an itinerary, reviewing content, sharing content, etc.

Review module 330 may be a hardware processor configured to organize user generated content received from a plurality of users. Review module 330 may be configured to rate, categorize, sort, and order the user generated content based on a plurality of factors. In embodiments, the most relevant content is presented to the user or published, wherein the content may be published based on date, location associated with the content, subject of the content, etc. The plurality of factors may include user ratings, social shares, category of content, date associated with the user's travels, location, etc. In embodiments, users may rate content based on a plurality of factors, such as the helpfulness of the review, the quality of the writing, whether the user agrees with the content, etc.

Review module 330 may be configured to determine how many times content has been shared, tweeted, liked, etc. by the users within the travel group, wherein the rating may be based on the number of interactions of the content on at least one social network.

Review module 330 may be configured to rate the content based on the reviews and/or interactions with the content on social networks by users within the travel group. Therefore, review module 330 may be configured to rate the content based on the user's within a travel groups preferences, likings, etc., such that only users within the travel group may determine what content is most relevant to the travel group. The ratings may include a first weight given to the review scores and a second weight may be given to the number of interactions of the content on social networks, wherein the first weight and the second weight may be equal or different weights.

Schedule module 335 may be a hardware processing device configured to receive a blank itinerary for the travel group. The blank itinerary may include a destination location (e.g. a country, city, theme park, tourist attraction, etc.), a time period (e.g. from a first date to a second date, start date to end date), length of time (e.g. one hour, two hours, etc.), cost desired to spend on the trip, number of people in the user's group, etc. The blank itinerary for the trip may be further broken down into a number of sub-activities that the user may desire to attend during the trip, wherein the sub-activities may include a number of breakfast restaurants, a number of lunch restaurants, a number of dinner restaurants, a number of evening points of interest to visit, a number of daytime points of interest to visit, etc. In embodiments, the trip planner may set dates and/or times that the travel group desires to visit a specific location at a specific date on the blank itinerary. For example, the trip planner may set that on the first date of the trip the user desires to visit a first restaurant for lunch and a first point of interest for an evening activity. Therefore, the trip planner may have control of the itinerary.

Itinerary module 340 may be a hardware processor configured to generate a travel itinerary for the travel group. Itinerary module 340 may be configured to generate the itinerary in response to a trip planner generating a blank itinerary, the user generated content, and the ratings of the user generated content by users within the travel group. Itinerary module 340 may be configured to fill the blank itinerary filled with activities associated with user generated content, such as restaurants to eat at, points of interest to visit during the day, points of interest to visit during the night, etc. The blank itinerary may be filled with activities based on a plurality of factors, such as ratings, cost, location, time period, etc. associated with the restaurants, points of interest, content rating, number of times the content has been shared on a social network, etc. Therefore, itinerary module 340 may be configured to dynamically generate an itinerary for the travel group based on the travel group's blank itinerary, preferences of the users within the travel group, time of travel, and/or the ratings of the other users' generated content. Accordingly, a first travel group desiring to visit a first location may be given a different itinerary than a second group desiring to visit the first location because the preferences of the users within the group may vary. The dynamically generated itinerary may be made with little or no input from the users of the travel group other than the users rating the user generated content. Itinerary module 340 may also include a module configured to receive content from a user while the user it the location while on a trip. Therefore, the user may add content to be viewed, reviewed, and/or shared by other users, wherein the user's generated content may be used to plan activities for other travel groups.

Publishing module 345 may be a hardware processing device configured to transmit information to be published in physical media, such as a pamphlet, book, itinerary, or be presented on a graphical user interface of a client computing device 120. Publishing module 345 may be configured to publish or present information associated with user generated content and itineraries for a travel group. Publishing module 345 may be configured to publish or present user generated content based on a plurality of factors, such as the ratings of the user generated content, a time period associated with the user generated content, the location of the content, subject of the user generated content, etc. For example, publishing module 345 may be configured to publish user generated content that are the three highest rated pieces of content associated with restaurants in a first city for travelers, wherein the pieces of content are associated with users that traveled during February. In further embodiments, publishing module 345 may be configured to publish itineraries associated with the travel group.

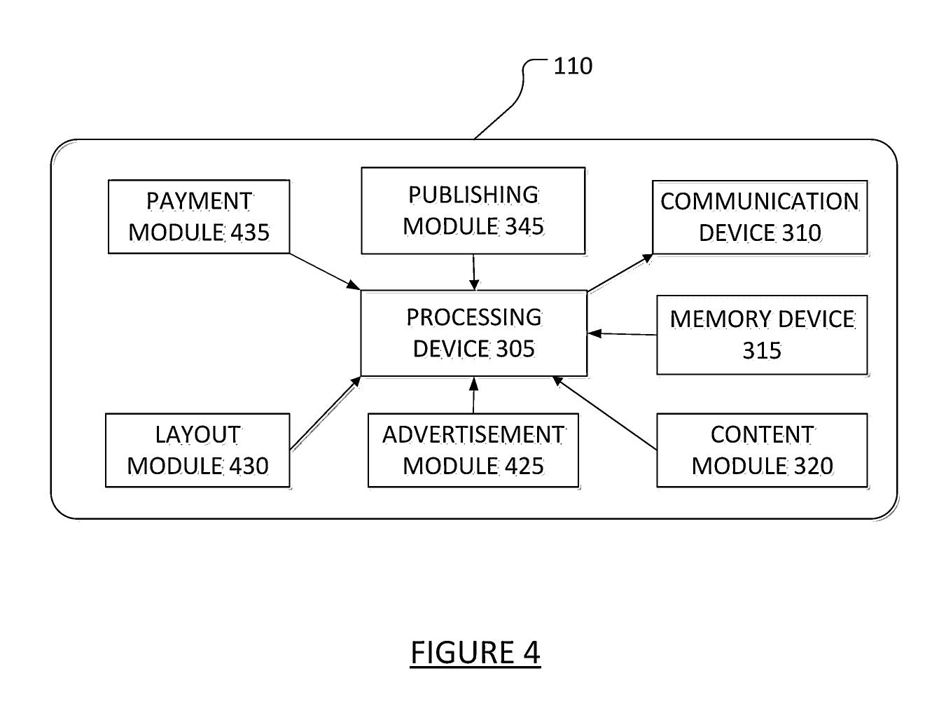

FIG. 4 depicts one embodiment of travel server 110. Certain elements of FIG. 4 may be substantially the same as elements described in FIG. 3. Therefore, for the sake of brevity another description of these elements is omitted. Travel server 110 may include a processing device 305, a communication device 310, a memory device 315, a content module 320, an advertisement module 425, a layout module 430, a payment module 435, and a publishing module 345.

Advertisement module 425 may be a hardware processor configured to receive revenue from advertisement companies in response to advertisements being presented along with user generated content. In embodiments, the advertisements may be received from an advertisement computing device 140 associated with an advertisement company, where the advertisement company is enabled to upload advertisement(s). For example, advertisements which may be uploaded include an advertisement company's name, slogan, logo, text, message, sound, animation, video, and/or the like, and combinations thereof. Further, advertisements may be of any size or duration. For example, relatively short “banner” advertisement(s). Also, advertisements may further include watermarks, overlays, and/or the like. In at least one embodiment, advertisements include mouse-over advertisements, click-through advertisements, interactive games, short surveys, and/or the like.

Layout module 430 may be a hardware processing device configured to allow a user creating content to select a layout and advertisements that are displayed along with the user generated content. In embodiments, the selected layout may include various placements for the text, media, and advertisements, wherein each page of user generated content may have a different layout. Furthermore, layout module 430 may allow a user that created the content to select an advertisement to be presented along with the user generated content, such that relevant advertisements may be displayed along with the content.

Payment module 435 may be a hardware processor configured to receive revenue from advertisements in response to displaying advertisements along with user generated content, and deliver the revenue to the user that generated the content and non-profit organizations. In embodiments, the amount of revenue given to the user generating the content and/or the advertisement may vary on a plurality of factors, including rating of content, number of views of advertisements, subject of content, subject of advertisements, wherein if the subject of the advertisement and the subject of the advertisements are related the amount of revenue given to the user may increase. Furthermore, in embodiments, the user may be able to select the non-profit organization that receives revenue associated with revenue generated by the content, wherein the non-profit organization may be associated with the subject and/or location of the content.

Publishing module 345 may be a hardware processing device configured to publish content on physical media and/or a graphical user interface on a client computing device. In embodiments, publishing module 345 may be configured to publish the user generated content in the layout selected by the user, such that different pages on the physical media or graphical user interface may have different layouts.

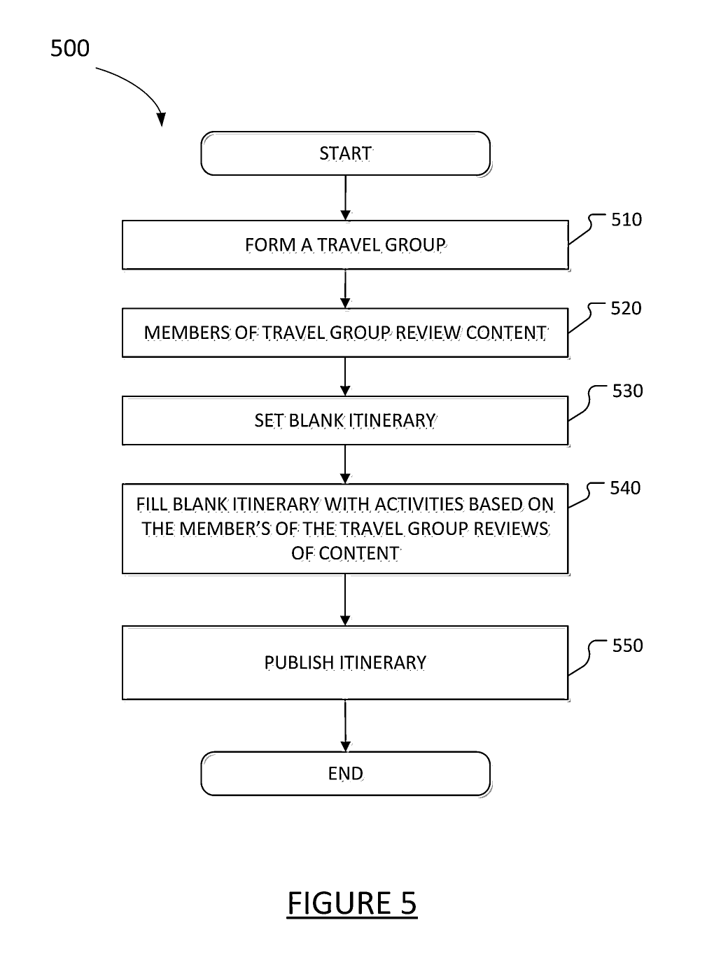

FIG. 5 illustrates a method 500 for determining a travel itinerary for a group. The operations of method 500 presented below are intended to be illustrative. In some embodiments, method 500 may be accomplished with one or more additional operations not described, and/or without one or more of the operations discussed. Additionally, the order in which the operations of method 500 are illustrated in FIG. 5 and described below is not intended to be limiting.

In some embodiments, method 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 500 in response to instructions stored electronically on an electronic storage medium. The one or more processing devices may include one or more devices configured through hardware, firmware, and/or software to be specifically designed for execution of one or more of the operations of method 500.

At operation 510, a travel group may be formed, wherein the travel group may include a single user or a plurality of users. The travel group may be formed on an online community or social network. The travel group may be users that desire to visit the same location over the same time period, such as a tour group with a tour guide. In embodiments, the travel group may form a social network by a travel planner (e.g. a tour guide) transmitting request to users to join the travel group and form a social network. In further embodiments, the travel group may be formed responsive to the users of the group transmitting messages desiring to be included in the travel group. Operation 510 may be performed by a group module that is the same as or similar to group module 235, in accordance with one or more implementations.

At operation 520, members of the travel group may review content on a website and/or share the content with other members of the travel group. The members may review content by reading the content and assigning a rating (e.g. a numerical rating, a star rating, etc.) to the content. The members may share the content with other members of the travel group over a social network by liking the content, tweeting about the content, linking to the content, etc. To this end, members of the travel group may be able to form travel preferences, events, activities, dining experiences that they wish to partake in while the travel group is traveling, wherein the content with the highest average reviews and most shared content on the social network may be rated the highest. Operation 520 may be performed by a review module that is the same as or similar to review module 330, in accordance with one or more implementations.

At operation 530, a trip planner may set a blank itinerary for the travel group. The blank itinerary may include a destination location (e.g. a country, city, theme park, tourist attraction, etc.), a time period (e.g. from a first date to a second date), length of time (e.g. one hour, two hours, etc.), cost desired to spend on the trip, number of people in the user's group, etc. The blank itinerary for the travel group may be further broken down into a number of sub-activities that the user may desire to attend during the trip, wherein the sub-activities may include a number of breakfast restaurants, a number of lunch restaurants, a number of dinner restaurants, a number of evening points of interest to visit, a number of daytime points of interest to visit, etc. Operation 530 may be performed by a schedule module that is the same as or similar to schedule module 335, in accordance with one or more implementations.

At operation 540, an itinerary for the travel group may be generated. The itinerary may be generated in response to the blank itinerary, the user generated content, and the ratings of the user generated content by users within the travel group (e.g. reviews and/or number of times the user generated content is shared on social networks by the travel group's members). The itinerary may be filled with activities based on a plurality of factors, such as ratings or popularity of the user generated content, the number of slots within the blank activity for each type of activity (e.g. three dining opportunities, two museums, two extrusions, etc.), etc. Therefore, the itinerary may be dynamically generating for the travel group based on the travel group's blank itinerary, preferences of the users within the travel group, time of travel, sharing of the user generated content, and/or the ratings of the other users' generated content, wherein different travel groups may have different itineraries based on the travel group's member preferences. Operation 540 may be performed by an itinerary module that is the same as or similar to itinerary module 340, in accordance with one or more implementations.

At operation 550, the itinerary for the trip may be published. The itinerary may be published along with the user generated content that was the highest rated among the users within the travel group, wherein the rating may be based on review metrics and/or the number of interactions with the content on social networks. The itinerary may be published on physical media and/or on digital media, such as an e-book or mobile application. Operation 540 may be performed by a publishing module that is the same as or similar to publishing module 345, in accordance with one or more implementations.

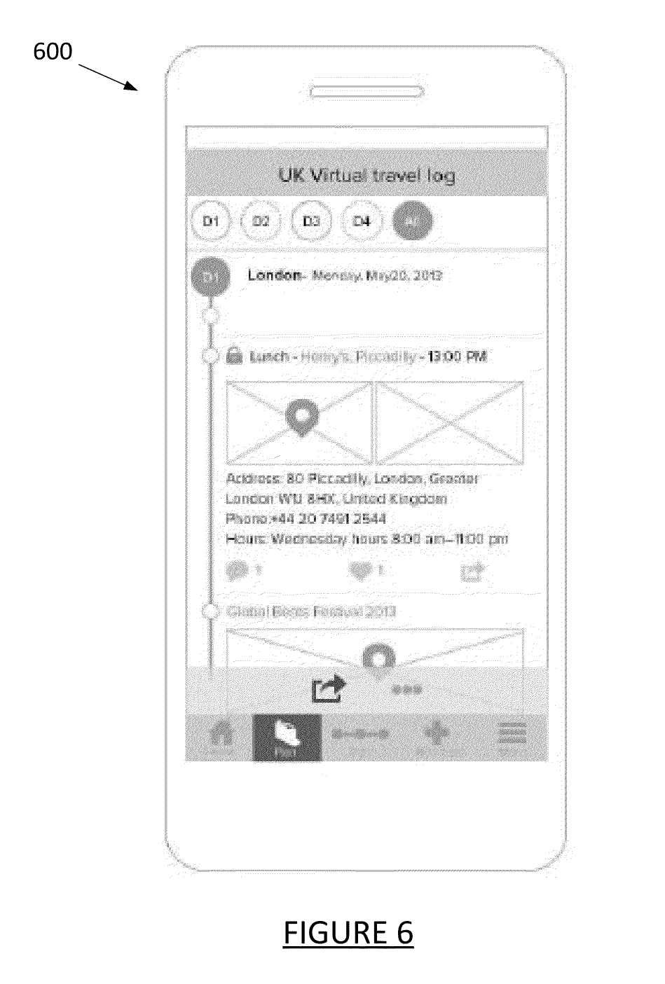

FIG. 6 depicts one embodiment of a graphical user interface 600 presenting content on a client computing device 120. The content presented on graphical user interface 600 may include a location associated with a travel log, an activity that the user may attend, wherein the activity includes a location, date, and contact information. In embodiments, the user may scroll the graphical user interface 600 on client computing device 120 to view other content or activities within the activity.

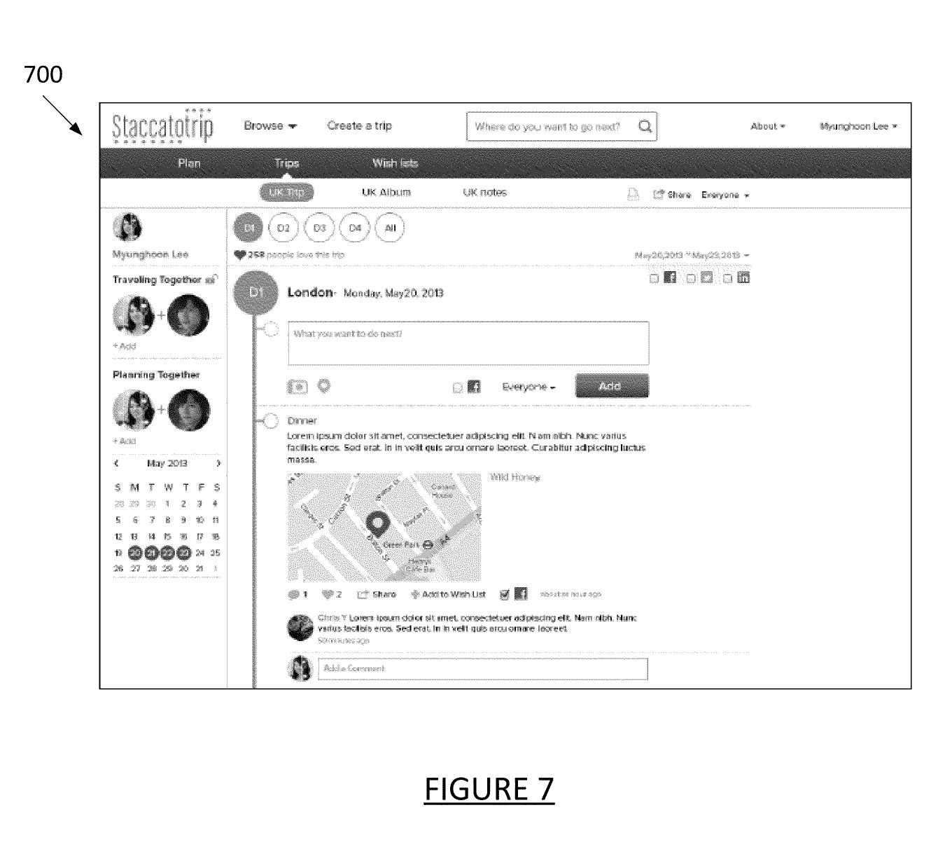

FIG. 7 depicts one embodiment of a graphical user interface 700 presenting content on a client computing device 120. Graphical user interface 700 may include content generated by other users about a location, event, etc., wherein the user may review the content generated by other users, share the content generated by other users, and/or create their own content associated with the location, event, etc. In embodiments, graphical user interface 700 may also include a travel group of users that desire to travel together, a location associated with the destination, and a time period. Via graphical user interface 700 the user may view their trip itinerary, create content, review content, and/or share content with others within their travel group.

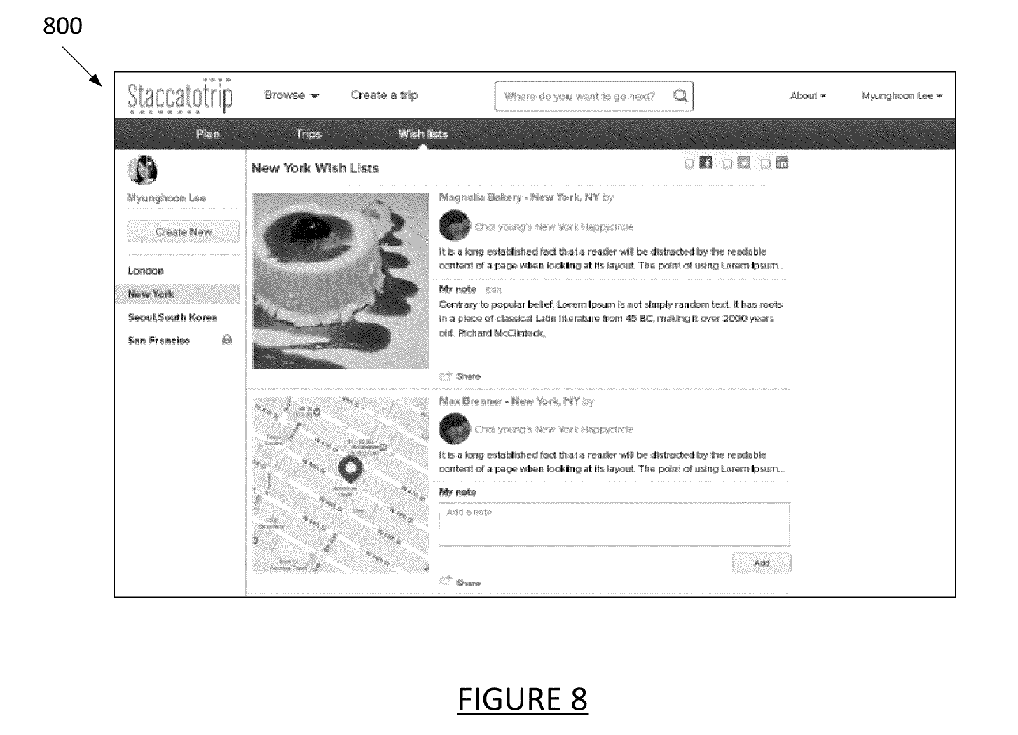

FIG. 8 depicts one embodiment of a graphical user interface 800 presenting content on a client computing device 120. Graphical user interface 800 may include content generated by the user and/or other users. Graphical user interface 700 may also allow the user to comment, review, and/or share the content with other users.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagrams.

What is claimed is:

1. A system for planning travel, the system comprising:
a review module configured to receive ratings for pieces of content, wherein each of the pieces of content is associated with a location and a type of activity;
a group module configured to form a travel group desiring to travel to the location;
an itinerary module configured to receive a blank itinerary for the travel group, wherein the blank itinerary includes a location and a plurality of activities to be performed at the location, wherein each of the plurality of activities has an associated time and type; and
a schedule module configured to fill activities within the blank itinerary based on the location, type of activities within the blank itinerary, the ratings of the pieces of content, and the type of activity associated with the pieces of content.

2. The system of claim 1, wherein the travel group includes a plurality of users that are connected over a social network.

3. The system of claim 2, wherein the rating of the pieces for the pieces of content include reviews and social interactions by the users within the travel group.

4. The system of claim 3, including a first travel group comprised of a first group of users and a second travel group comprised of a second group of users, wherein the blank itinerary for the first travel group is filled with a first set of activities based on the ratings of the pieces of content by the users within the first travel group and the blank itinerary for the second travel group is filled with a second set of activities based on the ratings of the pieces of content by the users within the second travel group.

5. The system of claim 1, wherein the plurality of activities are associated with at least one of an eating experience, drinking experience, points of interest and activities, theme park, museum, historical landmark and art exhibit.

6. The system of claim 1, further comprising:
an advertisement module configured to receive revenue from an advertisement company in response to an advertisement being displayed with a piece of content.

7. The system of claim 6, wherein the piece of content is generated by a user, and the user selects the advertisement to be displayed with the piece of content and a layout of the piece of content and the advertisement.

8. The system of claim 7, wherein the revenue received from the advertisement company is distributed to the user and a non-profit organization, wherein the non-profit organization is selected by the user, associated with the piece of content, and associated with the advertisement.

9. The system of claim 1, wherein the blank itinerary is set by a travel planner, the travel planner being one of the users within the travel group.

10. The system of claim 1, wherein the activities that fill the blank itinerary are the pieces of content with the highest rating being associated with a same type of activity as an activity within the blank itinerary.

11. A method for planning travel, the method comprising:
receiving ratings for pieces of content, wherein each of the pieces of content is associated with a location and a type of activity;
forming a travel group desiring to travel to the location;
receiving a blank itinerary for the travel group, wherein the blank itinerary includes a location and a plurality of activities to be performed at the location, wherein each of the plurality of activities has an associated time and type; and
filling activities within the blank itinerary based on the location, type of activities within the blank itinerary, the ratings of the pieces of content, and the type of activity associated with the pieces of content.

12. The method of claim 11, wherein the travel group includes a plurality of users that are connected over a social network.

13. The method of claim 12, wherein the rating of the pieces for the pieces of content include reviews and social interactions by the users within the travel group.

14. The method of claim 13, further including:
forming a first travel group comprised of a first group of users;
forming a second travel group comprised of a second group of users, wherein the blank itinerary for the first travel group is filled with a first set of activities based on the ratings of the pieces of content by the users within the first travel group and the blank itinerary for the second travel group is filled with a second set of activities based on the ratings of the pieces of content by the users within the second travel group.

15. The method of claim 11, wherein the plurality of activities are associated with at least one of an eating experience, drinking experience, points of interests and activities, theme park, museum, historical landmark and art exhibit.

16. The method of claim 11, further comprising:
receiving revenue from an advertisement company in response to an advertisement being displayed with a piece of content.

17. The method of claim 16, further comprising:
generating the piece of content is generated by a user;
selecting, by the user, the advertisement to be displayed with the piece of content; and
selecting, by the user, a layout of the piece of content and the advertisement.

18. The method of claim 17, further comprising:
distributing the revenue received from the advertisement company to the user and a non-profit organization, wherein the non-profit organization is selected by the user, associated with the piece of content, and associated with the advertisement.

19. The method of claim 11, further comprising:
setting the blank itinerary by a travel planner, the travel planner being one of the users within the travel group.

20. The method of claim 11, wherein the activities that fill the blank itinerary are the pieces of content with the highest rating being associated with a same type of activity as an activity within the blank itinerary.
